(19) United States
(12) Patent Application Publication
(10) Pub. No.: US 2019/0133072 A1
(43) Pub. Date: May 9, 2019

(54) Poultry Barn Debris Removal System

(71) Applicant: Daniel L. Hintsala, Negaunee, MI (US)

(72) Inventor: Daniel L. Hintsala, Negaunee, MI (US)

(21) Appl. No.: 16/182,946

(22) Filed: Nov. 7, 2018

Related U.S. Application Data
(60) Provisional application No. 62/583,011, filed on Nov. 8, 2017.

(51) Int. Cl. A01K 1/01; A01K 31/04

(52) U.S. Cl. CPC A01K 1/0128; A01K 31/04

(57) ABSTRACT

A guide frame extends along an aligned row of multilevel cages and mounting scrapers fit within a floor space between cage supports in a debris removal system in a poultry barn to be guided during advancing and retracting of the guide frames by pulling cables attached to each ends of the guide frames. Spaced pivoted scrapers are mounted extending between the sides of the guide frame which scrapers are positioned vertically when the guide frame is advanced to push debris forwardly along the floor areas between the cage supports but swing up when the guide frame is pulled back to move over collected debris. The debris is moved step by step along the guide frame by reciprocation of the scrapers mounted on the guide frame past the end of the row of cages and into a debris receiving discharge. The system may also include a guide frame with pivoted scraper blades fit to the width of a walkway between rows of cages which is also pulled in an advancing and retracting direction along the walkway floor synchronously with the cage guide frame but in a reverse direction to push debris forwardly step by step along the surface of both the floor under the row of cages and the walkway.

### CROSS REFERENCE TO RELATED APPLICATIONS

This application claims the benefit of provisional application No. 62/583,011 filed on Nov. 8, 2017.

### BACKGROUND OF THE INVENTION

This invention concerns poultry barns used to raise chickens and other poultry.

Past practices of poultry raising in which the poultry were confined in small cages only allowing very limited movement have changed in recent years.

In these more recent practices, a large number of chickens are allowed to move around large multilevel cages and to move out of the cage to forage for feed distributed on floor areas outside the cages. A number of large cages are arranged aligned with each other in long rows within a large building referred to as a barn. The poultry are able to move onto floor areas beneath the cages and also onto walkways extending alongside rows of the cages to forage on feed distributed on the floor beneath the cages and also on the walkway. This more “free ranging” approach makes for healthier poultry and is considered more humane, and is generally now required by law. However, it is desirable that the chickens move up from the floor and return to roosts in upper levels of the cages for sleeping and to lay eggs, as that location is where eggs are most conveniently collected.

It is necessary to regularly clear the floor areas beneath each cage and on the adjacent walkway of waste material, such as scattered feed, droppings, mortalities, eggs laid on the floor, etc. in the interests of cleanliness to prevent disease. Debris removing apparatus has been installed on the floor beneath the bottom of the cages, which comprises a series of plows spaced apart along a cable which is pulled in one direction to advance debris down the length of the cages by advancing a quantity of debris from plow to plow with each forward pulling stroke of the cable. A reverse pulling of the cable returns the plows to be positioned for a repeat advancement of the plows.

Fixed conveyor guides have also sometimes been used, such as features cast into the concrete floors or separate fixed guide pieces attached to a series of cage supports installed beneath each side of the cages to avoid impacting the cage supports with the plows as they are reciprocated within the space between the supports.

Wide clearances between the plows and the cage supports have also resorted to in order to avoid impacts with the cage supports.

Either of these measures resulted in the plows being sized to be much narrower than the space between the cage supports extending along each side of the cages. These measures have been deemed to be necessary since the plows often swing widely to either side when encountering masses of debris as the pull cable cannot restrain this sideways movement of the plows. Thus, the spaces beneath the cages typically ranges from 7-9 feet wide while the plows typically are only 18 to 30 inches wide and thus only a fraction of the floor areas below the cages are swept by the advance stroking of the plows. Considerable manual labor is necessitated to push debris lying beyond the relatively narrow plows and into the path of the plows so as to thereby be moved along to the discharge end by the plows. The plows therefore each receive and advance large volumes of debris. Large volumes of debris thereby remain and accumulate to each side of the plows, as manual efforts to move debris to the plows often cannot keep up with the accumulation of the debris.

The poultry have a tendency to lay eggs in the debris accumulating on either side of the plows, particularly since they are not much disturbed by the movement of the plows down the center of the space and don't normally sweep over the areas on the floor to each side of the plows.

Thus, much labor is required to not only move debris from the side areas into the path of the plows to be removed but is also required to remove the eggs in the debris.

The separate walkway floor area also accumulates such debris which must also be removed since the poultry are often also now allowed to forage over that floor area as well, in the interests of increasing physical activity of the poultry. The debris on the walkways is typically removed by manual sweeping, usually at the same time when moving a ladder and cart along the walkway to facilitate inspection of the upper levels of the cages.

Thus a considerable increase in the manual labor results in the execution of these new “free range” practices.

### SUMMARY OF THE INVENTION

The present invention utilizes scrapers which are mounted extending completely across sides of a generally rectangular cage guide frame configured to occupy substantially the entire space between the cage supports so as to sweep debris from substantially all of the entire area between the supports on either side of the cages, excepting only a minimal clearance between the supports and the sides of the guide frames to insure free movement of the guide frame between the two series of cage supports. The guide frame extends along the row of cages and this prevents substantial lateral movement of the scrapers so as to not require large clearances between the scrapers and the cage supports so as to allow scraping of the complete space between the supports. Angled front and back ends attached to the guide frame are also provided, which are attached to a cable or cables used to reciprocate the guide frames which also tend to prevent impacts of the guide frames with the cage supports.

As noted, the guide frame with the scrapers mounted thereto is reciprocated by a cable or cables attached to either angled end of the guide frame to move debris material step by step towards a forward end of the rows of cages. In a return stroke, the scrapers are pivoted up to pass over the collected debris material forward of each scraper to minimize back movement of the debris by reverse movement of the scrapers.

The scraping of debris substantially all across the entire floor space between the supports avoids a larger accumulation of debris anywhere beneath the cages to not require manual redistribution. Also, the movement of the relatively long scrapers passing across the entire space beneath the cages quite effectively discourages the poultry from nesting or laying eggs on the floor, as well as the elimination of accumulations of debris anywhere in the floor space. The poultry thus are induced to ascend to one of the elevated cage levels for nesting and egg laying while still allowing foraging activity anywhere on the floor.

A further aspect of the invention is to provide a separate walkway guide frame with mounted scrapers which remove debris from the walkway floor area. The walkway guide frame has shorter scrapers of the lesser length extending between the opposite sides of the walkway guide frame. The walkway guide frame is also reciprocated in advancing and return directions by pulling cables, and the trailing end of each of the cage and walkway guide frames are connected together by a common pull cable so that when the cage guide frame is advanced, the walkway guide frame is moved in a return direction and when the cage guide frame is returned, the walkway guide frame is advanced.

The use of the scrapers which extend substantially completely across the entire space between the cage supports prevents debris material at any point along the length of the scrapers which debris is moved forward step by step to a discharge location at the end of each of the rows of cages serviced by the guide frame and scrapers.

The movement of the guide frames and scrapers is sufficiently slow (7-10 feet a minute has proven to be workable) and the minimized height of the scrapers enabled by the debris not accumulating at any point along the entire length of the scrapers allows the poultry on the floor areas being scraped easily avoid the scrapers by stepping over the same. Additionally, a cover can be mounted on the top of the scrapers to assist the poultry in avoiding being caught by the scrapers.

Also, manually moving collected debris on side areas of the floor beneath the cage to the front of the scrapers is eliminated to greatly reduce the labor necessary to maintain these floor areas free of debris accumulation. The manual sweeping of the walkway may also be eliminated, and the need to remove eggs from the debris on the floor or the walkway is eliminated.

Scrapers of various configurations can be installed such as notched scrapers to allow a certain amount of “scratch” to remain on the floor after the scrapers have passed over the floor and thus be able to be foraged by the poultry. A rubber plow scraper can also be installed for cleaning of the floor as by using disinfectants rubbed on the floor surface by the scrapers.

Each end of the scrapers is pivotally mounted to a respective side of the associated guide frame. The guide frame sides can be formed by connected together elongated bars or plates connected together and to form the complete sides of the guide frame by a segmented design.

The length of the scrapers may be set to substantially sweep 95% of the width of the floor space between the cage supports since a guide or track system fixed to the floor or guide features formed in the floor itself are not necessary as in conventional designs and the large clearances for the scrapers are also not necessary since the guide frame minimizes any lateral movement of the scrapers.

The segmented design of the guide frame sides allows the length of the guide frame to be matched to the length of the row of cages with which the guide frame is to be used. An angled end is connected to each end of the guide frame, a pulling cable attached to the point of each angled end which ends also avoid impacts with the cage supports.

### DESCRIPTION OF THE DRAWING FIGURES

FIG. 1 is a diagrammatic plan view of a typical prior art debris removal system located on the floor beneath a multilevel cage.

FIG. 1A is a diagram of several side by side rows of cages each having a conventional debris removal system of the type shown in FIG. 1.

FIG. 2 is a diagrammatic plan view of a debris removal system according to the present invention.

FIG. 2A is a diagrammatic plan view of a debris removal system shown in FIG. 2 provided for each of a plurality of rows of cages.

FIG. 3 is a plan view of the debris removal system according to the invention which pushes debris along floor areas beneath a row of cages and also on a walkway extending along the row of cages shown in FIGS. 2 and 2A.

FIG. 4 is an enlarged sectional view taken through a floor on which the cages rest and showing a scraper mounted to a guide frame, the scraper in the vertical position assumed when pushing floor debris forward by forward movement of the guide frame.

FIG. 4A is an enlarged sectional view taken through the floor and a scraper mounted to the guide frame in a swung up position assumed by the scraper when the guide frame is retracted after completion of an advancing stroke.

FIG. 5 is a view of two successive scrapers mounted to a fragmentary part of a guide frame of a system as shown in FIG. 3, advancement of a collection of debris by each scraper depicted therein.

FIG. 5A is a diagram of two successive scrapers in a retracted position to the rear of a collected quantity of debris material, indicating the relationship between the length of the scraper spacing and the stroke distance thereof necessary to advance the debris step by step along successive scrapers in a cage floor guide frame.

FIG. 6 is a fragmentary view of a portion of a scraper installation showing a top cover provided to aid poultry in avoiding getting caught in a scraper during a forward stroking motion of the guide frame.

FIG. 7 is an enlarged plan view of the cover shown in FIG. 6.

FIGS. 8A-8C are front views of scrapers of varying configurations useable in the debris removal system according to the invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

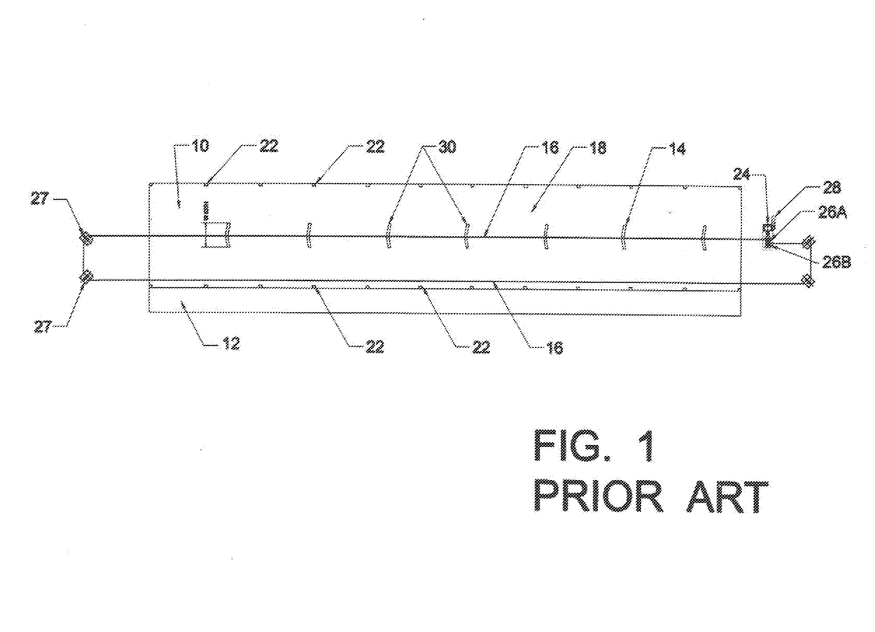

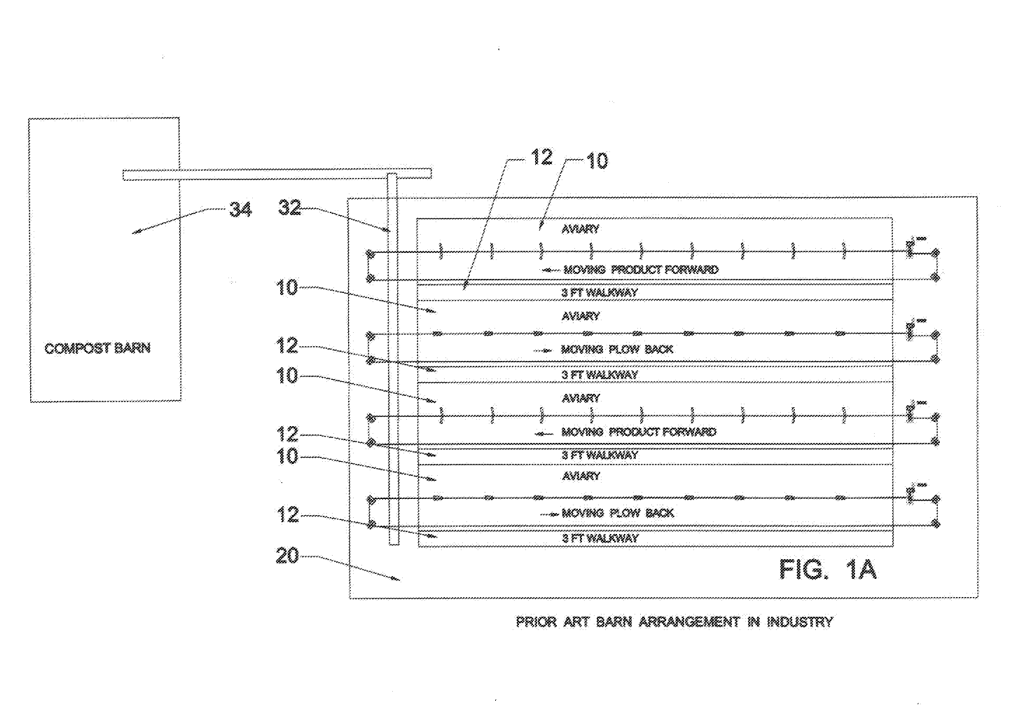

FIG. 1 depicts a typical prior art debris removal system which is mounted below the bottom of a series of aligned conventional multilevel cages 10 which in turn are mounted on supports 22 to be elevated above the surface of a floor 20 beneath the cages 10.

A walkway 12 is defined on the floor 20 extending alongside adjacent row of cages 10, (FIG. 1A).

A typical debris removal system 14 is mounted in a space 18 extending beneath the lowest level of the multilevel cage 10 and above the floor area 20 beneath the cage 10 which space 18 typically is about a foot high.

The poultry are able to descend from upper cage levels (not shown) to the floor 20 beneath each cage 10 by suitable cage features such as ladders as are well known in the art, and may also be able to move onto the walkway 12 which if so would have feed scattered thereon for foraging by the poultry. The poultry are encouraged to return to a cage level above the floor 20 where preferably egg laying takes place by various measures, such as locating water and feed troughs on an upper level of the cage.

Considerable debris is generated as described above, much of which ends up on the floor 20 below the cages 10 and on the walkway 12.

A first pulling cable 16 extends up the length of the cages 10 in the space 18, and out to a rotary drive assembly 24 located beyond areas accessible to the poultry. One end of the pulling cable 16 is wound up on a first windup reel 26A powered by a motor and gearing 28 to advance the series of spaced apart plows 30 attached thereto to the right a predetermined stroke distance such as 50 feet.

A second end of the cable 16 is routed around guide wheels 27 and is wound up on a second windup reel 26B to pull the cable 16 to the left by the motor and gearing 28 when activated.

As shown in FIG. 1A, the plow 30 are of a type designed to be pivoted up when the cable 16 is pulled back to the left to minimize back movement of any debris by the plow 30 when being stroked in a reverse direction.

It can be seen that there is a relatively large clearance from the outer edges of the plows 30 to where each of the series of cage supports 22 are located.

This clearance is deemed necessary because of the great tendency for the plows 30 to veer out sideways as when one side thereof encounters a heavy amount of debris or a large object and the plow could then hit one or more of the cage supports 22 and damage the same.

The debris is advanced step by step towards the right in FIG. 1 with each reciprocation of the cable 16, (shown advancing to the left in FIG. 1A) to move debris to a discharge conveyor 32 beyond the end of the row of cages 10, which collects the discharged debris and transports it to a composting barn 34.

It can be appreciated that a considerable proportion of the debris will tend to collect on the floor 20 in the spaces between the ends of the plows 30 and the cage supports 22, with the resulting drawbacks described above.

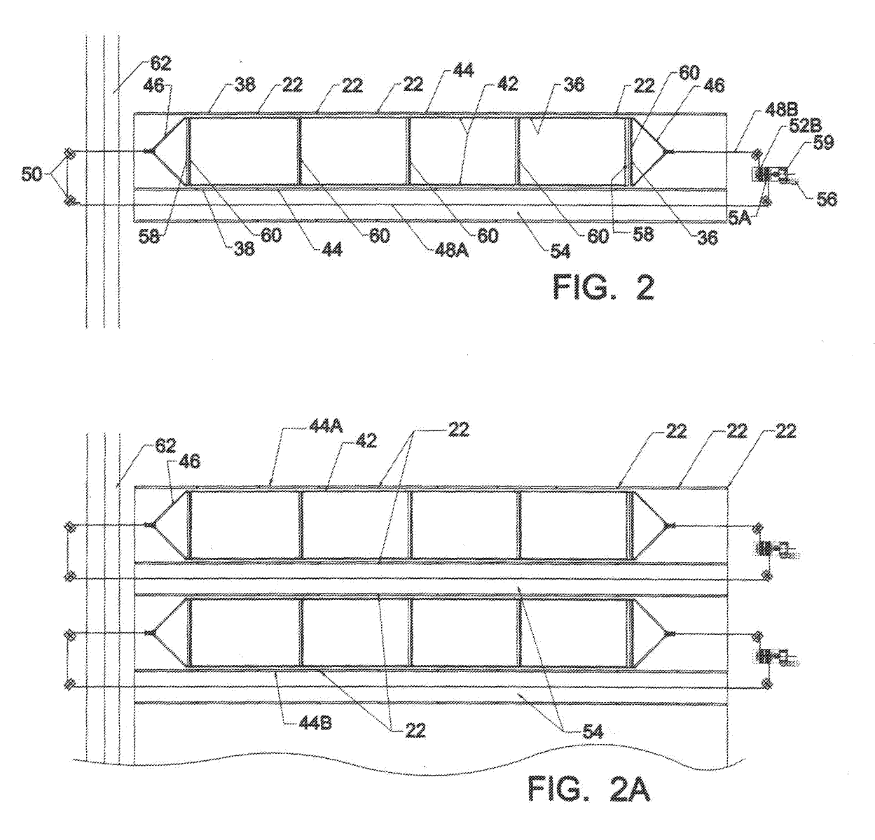

FIG. 2 shows a debris removal system according to the present invention, which features a generally rectangular guide frame 36 having parallel sides 42 closely fit to the space between the rows of cage supports 22 (see FIG. 1) below each side of the bottom 38 of the cages to leave only a minimal clearance between the supports 22 and the sides 42 of the guide frame 36.

The guide frames 36 are generally rectangular and having the parallel sides 42 and extends roughly the length of an aligned row of cages 44 which are occupied by poultry.

Angled ends 46 are attached to the guide frames 36 which have respective opposite ends of a pair of cable 48A, 48B attached thereto at the tips 46A, 46B of the angled ends 46. The angled ends 46 of the guide frame 36 minimizes the possibility of impacting a cage support 22 by an angle end 46 moving forward end of the guide frame 36 away from a support 22 if it is engaged by one side of the angled end 36. Also the guide frames 36 extend along a plurality of the cages 10 to maintain alignment when moved by the pulling cables 48A, 48B and thereby avoiding impacts with the supports 22.

One of the cables 48A is attached to the left end of the guide frame 36 and extends around a pair of guide wheels 50 to be routed back along the walkway 54 towards the other end of the guide frame 48B and wound onto a first rotary windup wheel 52A.

The second cable 48B is attached at one end to the opposite end of the guide frame 36 and wound up on a second rotary windup reel 52B.

Guide frame 36 has a series of parallel cross members 58 which extend across the guide frame 36 and are attached at each end to a respective one of the sides 42. The cross members 58 also support scrapers 60 as will be described in further detail below.

The guide frame 36 is reciprocated to advance debris step by step down the length of the row of cages 44 to the discharge end and the collected debris ahead of the last scraper is pushed onto a conveyor 62 to be moved thence into a compost barn (shown in FIG. 1A) as per conventional practice.

FIG. 2A shows two rows of cages 44A, 44B mounted side by side each with a walkway 54 therebetween and identical debris removal systems for each row of cages 44A, 44B.

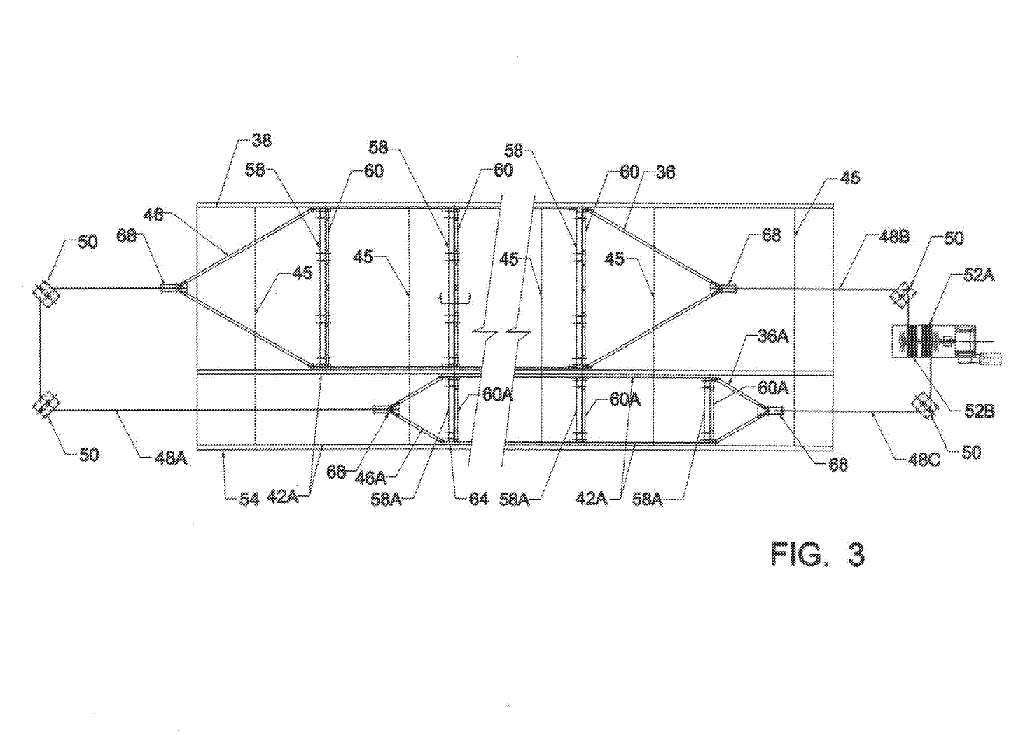

FIG. 3 shows a row of cages 44 associated with a debris removal system according to the invention which operates not only on the floor area beneath a series of aligned cages 44 (cage separation walls 45 indicated are included in conventional practice) but also on the walkway 54 extending alongside and between the two row of cages 44. The walkway 54 also has a generally rectangular guide frame 64 which is freely movable along the walkway 54 by the provision of a clearance space between two series of adjacent cage supports 22 and the outer sides 42 of the cage guide frame 36 and between the outer side 42A of the walkway guide frame 36, the supports 22 (see FIG. 1) located along the outer sides of the cages 44A, 44B.

A clearance of about 5% of the space between the guide frame 36 and the supports 22 has been found to be sufficient, i.e., the guide frame 36 has a width of about 95% of the total distance between rows of supports 22 on either side of the cages 10.

Thus, the scrapers 60 and 60A extend almost completely across those spaces to effectively push any debris thereon forwardly and substantially completely clear the floor area beneath the cages 44A, 44B and defined by the walkway 54.

When clearing both the floor beneath the cages 44A, 44B and the surface of the walkway 54, the pulling stroke of the cage guide frame 36 and the walkway guide frame 36A are preferably synchronized but occurs in opposite directions, involving three cables 48A, 48B and 48C.

Cable 48A is secured at one end to the trailing end of the cage guide frame 36 as with a cable connector 68 and is routed around guide wheels 50 to extend forwardly to the trailing end of the walkway guide frame 36A, with another cable connector 68.

Another cable segment 48B is attached with a connector 68 to the forward angled end 46 of cage guide frame 36 and thence to a powered windup reel 52B.

A third cable segment 48C is attached at one end to windup reel 52B, re-routed around guide wheels 50 and thence to the leading end of walkway guide frame 36A with another connector 68.

Thus, when windup reel 52B is activated, the cage guide frame 36 is advanced.

At the same time, walkway guide frame 36A must be retracted by cable segment 48A, and windup reel 52 unwinds cable to allow that movement.

When cable segment 48B is reversed, and retracted by windup cable segment 48C on reel 52A, windup reel 52B pays out cable to accommodate this.

At the same time, walkway guide frame 36A is advanced by the windup of cable 48C on reel 52A.

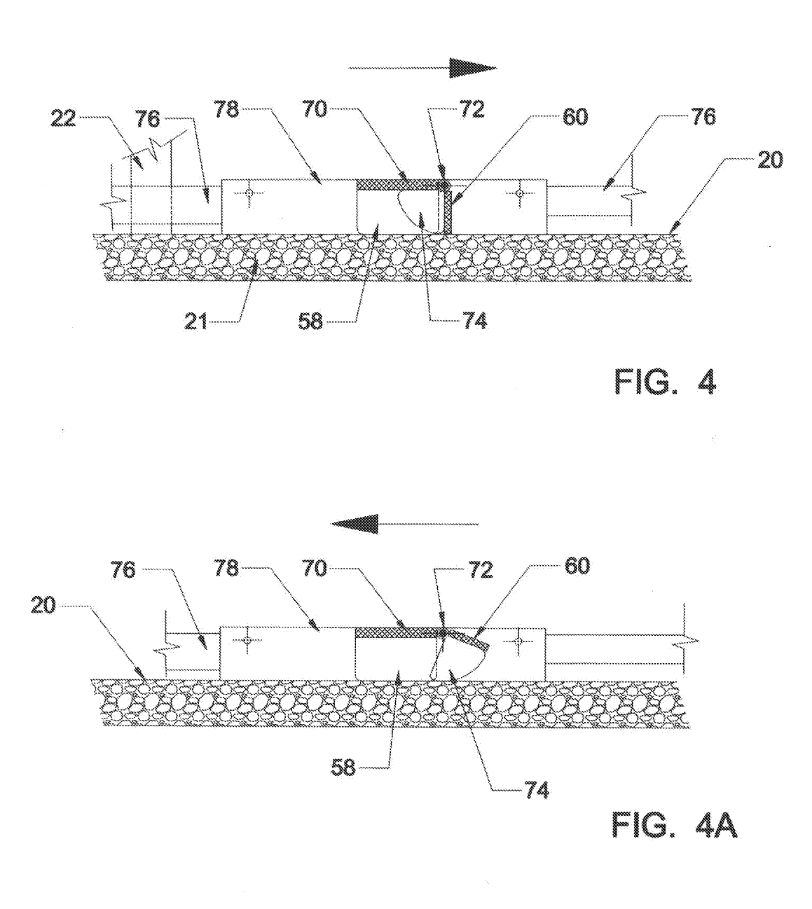

FIG. 4 is an enlarged partially sectioned view through a cross member 58 which also includes a top bar 70, a plow scraper hinge 72, and a scraper cam 74 is shown in a vertical pushing condition existing when the cage guide frame 36 is being advanced carrying all the scrapers forward to push debris to a position forward of the next scraper 60.

The cross members 58 together with a top bar 70 are attached to a segment of a guide frame side 42 comprised of a plurality of side bar pieces 76 connected together to create the guide frame sides 42 sides to be matched to the overall length of the guide frame 36.

A scraper support end connector plate 78 may also be used to splice together aligned side pieces 76.

FIG. 4A shows the swung up positioning of the scrapers 60 when the guide frame 36 is being retracted to pass over gathered debris.

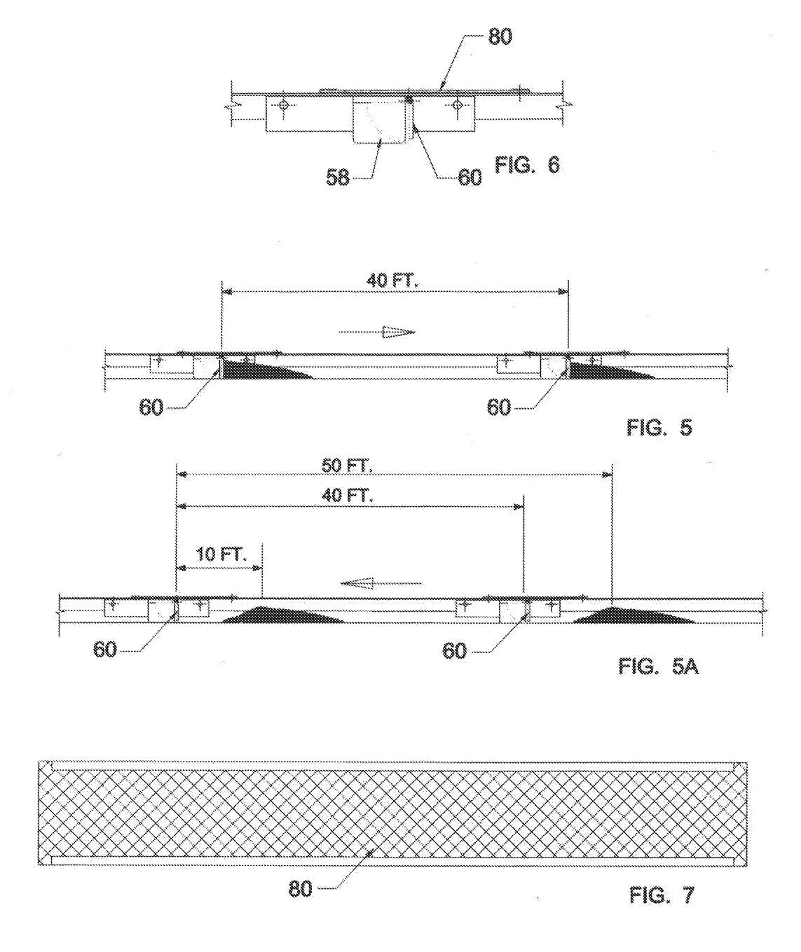

FIGS. 5 and 5A depict the relationship between the spacing and the stroke length of the plow scrapers 60.

The stroke of 50 feet indicated will position the retracted scrapers 60 to the rear of collected debris piles if the scrapers 60 are spaced 40 feet apart.

This will yield the successive advance of captured debris.

FIGS. 6 and 7 show an installation of a cover 80 made of expanded metal over the top of the cross member 58 at a point at the center of the scraper 50 which will assist chickens attempting to climb over the scraper 60. The speed of the scrapers 60 is sufficiently slow (7-10 feet a minute has been found to be workable) and contributes to the physical activity of the poultry.

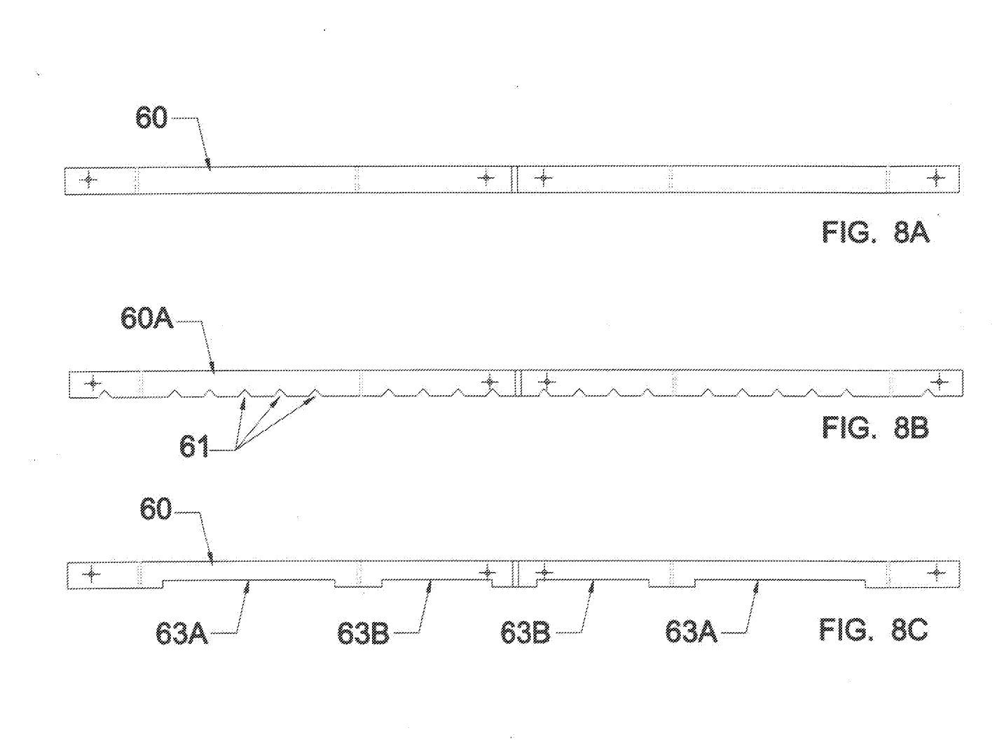

Referring to FIGS. 8A-8C, different versions of the scrapers 60 are depicted.

In FIG. 8A, a regular straight scraper 60 is depicted, which may be constructed of steel for maximum strength and durability.

However, the scrapers 60 may also be constructed of rubber, as to be able to clean the floor surface with a cleansing disinfecting liquid, rubbed in by the reciprocating motion of the guide frames 36 and 36A. Such rubber scrapers may be temporarily installed for that purpose and then removed and replaced with the steel scrapers 60.

The plow scrapers 60 may also be constructed of UHMW plastic to reduce weight and costs.

The scrapers 60A shown in FIG. 8B can be formed with small notches 61 to allow some material including feed to remain on the floor to get the poultry to forage on the floor.

The scrapers 60B can also have varying width larger cutouts 63A, 63B as shown in FIG. 8C if a larger quantity of food containing debris left behind is desired.

1. A debris removal system for removing debris collected on a floor in a poultry barn having a row of aligned multilevel cages, supports on either side of said cages positioning a bottom of said cages above said floor, said system comprising;
a guide frame on said floor having sides closely fit in a space extending between said cage supports on either side of said cage, said guide frame extending along the length of said row of cages;
a plurality of elongated scrapers each having opposite ends pivotally mounted to said guide frame extending across said guide frame, said scrapers in a vertical position when moved in an advancing direction beneath said cages by a reciprocating pulling cable attached at a forward end of said guide frame advanced by a pulling drive and swung up when retracted by engagement with accumulated debris on said floor to pass over accumulated debris and a pulling cable at a trailing end of said guide frame reciprocated by a reversely acting pulling drive to be ready to again be advanced in a next advancing stroke of said guide frame;
said debris advanced into a discharge adjacent one end of a furthest advanced scraper.

2. The debris removal plow system according to claim 1 wherein said guide frame has elongated angled ends attached thereto converging to a point where said forward and reverse pulling cables are attached to said guide frame thereby preventing impacts of said supports by an end attached to said guide frame.

3. A debris removal system according to claim 1 wherein a walkway floor space extends along one side of said row of cages and wherein a rectangular narrower walkway guide frame is disposed on said walkway closely fit within a width of said walkway with a clearance with said cage supports sufficient to insure free reciprocating movement of said walkway guide frame along said walkway;
One or more elongated scrapers extending between sides of said walkway guide frame said walkway scrapers pivotally mounted thereto adapted to move along said walkway when advanced in a forward direction;
a walkway return cable attached to a trailing end of said walkway guide frame and extending rearwardly and around guides to be directed forwardly to a rear end of said cage guide frame and attached thereto;
an advancing walkway cable attached to a forward end of said walkway guide frame and a rotary drive when activated pulling said walkway advancing cable to thereby advance said walkway guide frame and one or more scrapers to sweep debris on said walkway in an advancing direction; and,
said walkway return cable drawing said walkway guide frame in a return reverse direction when said cage frame is advanced by said cage guide frame cable drive, said one or more scrapers pivoted up when said walkway frame is drawn in said return reverse direction.

4. A method of removing debris deposited on a floor on which an aligned series of aligned poultry bar multilevel cages are supported on supports an either side of a bottom of said cages comprising fitting a rectangular guide frame on said floor closely fit between said supports on either side of said cages and beneath a cage bottom with sufficient clearance with said support to be freely movable along said bottom of said cages;
pivotally mounting one or more scrapers extending across and attached to opposite sides of said guide frame to be moved along with said floor surface to sweep substantially completely over said floor areas between said supports;
a pulling cable drive attached to an end of said guide frame for pulling said guide frame along said direction to sweep debris on said floor in an advancing direction along said floor beneath said aligned series of cages to a discharge at an end of said series of aligned cages; and
thereafter retracting said guide frame and one or more scrapers after pivoting said one or more scrapers up to a generally horizontal position to minimize engagement with debris collected during said advancing movement of said one or more scrapers.
